(19) United States
(12) Patent Application Publication
(10) Pub. No.: US 2020/0234572 A1
(43) Pub. Date: Jul. 23, 2020

(54) PLATFORM AND METHOD FOR MONITORING AN INFRASTRUCTURE FOR TRANSPORT VEHICLES, ASSOCIATED VEHICLE, TRANSPORT SYSTEM AND COMPUTER PROGRAM

(71) Applicant: TRANSDEV GROUP, ISSY LES MOULINEAUX (FR)

(72) Inventors: Cem KARAOGUZ, PALAISEAU (FR); Alexis BEAUVILLAIN, MASSY (FR)

(21) Appl. No.: 16/743,000

(22) Filed: Jan. 15, 2020

(30) Foreign Application Priority Data
Jan. 17, 2019 (FR) 19 00421

(51) Int. Cl. G08G 1/01; G08G 1/00; G08G 1/052; G08G 1/017

(52) U.S. Cl. CPC G08G 1/0133; G08G 1/017; G08G 1/052; G08G 1/20

(57) ABSTRACT

Disclosed is a platform for supervising an infrastructure for vehicles, a target vehicle including an obstacle detection module with a predetermined field of view and a geolocation module that are embedded, the target vehicle being able to follow a predefined route, the platform including: an acquisition module for acquiring, at a current moment, at least one piece of information representative of the presence or absence, in a predetermined safety zone, of an element outside the target vehicle; and an analysis module for determining whether, at the current moment, the external element is in the field of view of the obstacle detection module of the target vehicle, and generating and sending a driving setpoint to at least one vehicle on the infrastructure when the external element is outside the field of view.

### BACKGROUND OF THE INVENTION

### Field of the Invention

The present invention relates to a platform for supervising an infrastructure for transport vehicles, in particular autonomous, at least one target vehicle comprising an obstacle detection module of predetermined range and a geolocation module that are embedded, said target vehicle being configured to follow a predefined route on the infrastructure.

The invention also relates to a vehicle, in particular autonomous, that is capable of moving on an infrastructure for transport vehicles that is supervised by such a supervision platform, at least one target vehicle comprising an obstacle detection module with a predetermined field of view and a geolocation module that are embedded, said target vehicle being configured to follow a predefined route on the infrastructure.

The invention also relates to a transport system comprising a fleet of vehicles, in particular autonomous, that are capable of moving on an infrastructure for transport vehicles, the fleet of vehicles comprising at least one target vehicle comprising an obstacle detection module with a predetermined field of view and a geolocation module that are embedded, said target vehicle being configured to follow a predefined route on the infrastructure.

The invention also relates to a vehicle, in particular autonomous, that is capable of moving on an infrastructure for transport vehicles that is supervised by such a supervision platform, at least one target vehicle comprising an obstacle detection module with a predetermined field of view and a geolocation module that are embedded, said target vehicle being configured to follow a predefined route on the infrastructure.

The invention also relates to a computer program including software instructions which, when executed by a computer, implement such a supervision method.

### Description of the Related Art

The invention relates to the field of the supervision of a fleet of transport vehicles on an infrastructure, in particular road or rail, and particularly the field of automatic driving of autonomous transport vehicles.

Indeed, in the field of the secure driving of vehicles, and in particular in autonomous driving (that is to say, autonomous piloting), one of the main issues is the early identification of obstacles on the path of a moving vehicle, making it possible to take corrective measures so that the vehicle does not strike these obstacles, as well as the transmission of information between each vehicle in the fleet and a corresponding piece of electronic equipment to a remote supervision platform of the fleet of motor vehicles.

The considered obstacles are of any type, for example stationary obstacles, such as safety railings, parked vehicles, or moving obstacles, for example other vehicles or pedestrians. It will be understood that it is critical to avoid any collision between a moving vehicle and such obstacles, and also to ensure a proper transmission of information between each vehicle and the supervision equipment.

Vehicles are known that are each equipped with at least one obstacle detection module configured to detect any obstacle entering its field of vision. However, such obstacle detection implemented by the vehicle alone is limited by the field of view of the obstacle detection module that it comprises.

Furthermore, vehicle driving assistance collective perception systems are known comprising communication devices able to identify obstacles in a circulation area via sensors, installed in the road and/or embedded in a plurality of separate vehicles, and able to inform the supervision platform thereof remotely. The remote supervision platform is able to determine and send a setpoint to a vehicle circulating in said road circulation area.

However, the transmission of this information from the platform to the vehicle is not always satisfactory, the quantity of collective perception data collected by the supervision platform to be relayed via the datalink sometimes being too substantial for the available bandwidth.

### SUMMARY OF THE INVENTION

The aim of the invention is to resolve the drawbacks of the state of the art by proposing a more effective remote supervision platform, in particular in case of limited data throughput of the communication link established with each supervised vehicle.

To that end, the invention relates to a platform for supervising an infrastructure for transport vehicles, in particular autonomous, at least one target vehicle comprising at least one obstacle detection module with a predetermined field of view and a geolocation module that are embedded, said target vehicle being configured to follow a predefined route on the infrastructure, the platform comprising:
an acquisition module configured to acquire, at a current moment, at least one piece of information representative of the presence or absence, in a predetermined safety zone comprising the predefined route, of an element outside the target vehicle, and

an analysis and regulating module configured to determine whether, at the current moment, the external element is in the field of view or outside the field of view of the obstacle detection module of the target vehicle, and configured to generate and send a driving setpoint to at least one vehicle on the infrastructure when the external element is outside the field of view of the obstacle detection module of the target vehicle.

Thus, with the supervision platform according to the invention, a driving setpoint is sent to at least one vehicle on the infrastructure that it supervises only when an external element, detected in a safety zone comprising the predefined route of a target vehicle, is outside the field of view of the obstacle detection module embedded in this vehicle.

In other words, the supervision platform makes it possible to anticipate any obstruction, in particular temporary, of the field of view of the obstacle detection module embedded in the target vehicle while filtering the quantity of collective perception data collected for example via sensors, installed in the road and/or embedded in a plurality of separate vehicles.

The supervision platform according to the invention is therefore improved relative to the supervision platform of the state of the art in particular through its analysis and regulation module, which is configured to systematically implement processing of the received data in order to limit the generation of driving setpoint(s) to be transmitted by making it subject to the meeting of a double condition, namely that the detected external element, in particular for example by a collective perception, is both in the predetermined safety zone comprising the predefined route of a target vehicle and outside the field of view of the obstacle detection module embedded in this same target vehicle.

According to other advantageous aspects of the invention, the supervision platform comprises one or more of the following features, considered alone or according to any technical possible combinations:

when the element external to the target vehicle is moving, the acquisition module is also configured to receive speed and/or acceleration information associated with the information representative of the presence of the external element;

the analysis and regulation module comprises a prediction tool configured to supply a prediction of the route of the external element and/or at least one prediction of a spatial-temporal contact position between the external element and the target vehicle on the predefined route;

the spatial-temporal position corresponds to an elliptical zone and wherein the prediction tool comprises an instrument for calculating parameters of the elliptical zone, the surface of the elliptical zone being proportional to a degree of uncertainty associated with the prediction supplied by the prediction tool;

the analysis and regulation module comprises a verification tool configured to verify, at least at one moment after the current moment, the validity of the prediction(s), and configured to adapt the driving setpoint to the later moment as a function of said validity;

the platform is configured to classify the external element according to several categories comprising at least:

another vehicle, separate from the target vehicle,

traffic congestion,

a pedestrian or group of pedestrians,

a bicyclist or group of bicyclists,

a construction or restricted traffic zone,

a weather phenomenon,

a natural obstacle,

and to adapt the type of setpoint based on the category of external element.

The invention also relates to a vehicle, in particular autonomous, configured to move on an infrastructure for transport vehicles supervised by a supervision platform according to any one of the preceding claims, at least one target vehicle comprising at least one obstacle detection module with a predetermined field of view and a geolocation module that are embedded, said target vehicle being configured to follow a predetermined route on the infrastructure,

said vehicle comprising a reception and processing module configured to receive and process a driving setpoint sent by the supervision platform in the presence of an external element both in a predetermined safety zone comprising the predetermined route and outside the field of view of the obstacle detection module of the target vehicle.

The invention also relates to a transport system comprising a fleet of vehicles, in particular autonomous, that are capable of moving on an infrastructure for transport vehicles, the fleet of vehicles comprising at least one target vehicle comprising at least one obstacle detection module with a predetermined field of view and a geolocation module that are embedded, said target vehicle being configured to follow a predefined route on the infrastructure,

further comprising a supervision platform as previously described and in that at least one vehicle of the fleet of vehicles comprises a reception and processing module configured to receive and process a driving setpoint sent by the supervision platform in the presence of an external element both in a predetermined safety zone comprising the predetermined route and outside the field of view of the obstacle detection module of the target vehicle.

The invention relates to a method for supervising an infrastructure for transport vehicles, in particular autonomous, at least one target vehicle comprising at least one obstacle detection module with a predetermined field of view and a geolocation module that are embedded, said target vehicle being configured to follow a predefined route on the infrastructure, the method being implemented by a platform for supervising the infrastructure for transport vehicles, in particular autonomous, at least one target vehicle comprising at least one obstacle detection module with a predetermined field of view and a geolocation module that are embedded, said target vehicle being configured to follow a predefined route on the infrastructure, the method being implemented by a supervision platform of the infrastructure, the method comprising the following steps:
acquiring, at a current moment, at least one piece of information representative of the presence or absence, in a predetermined safety zone comprising the predefined route, of an element outside the target vehicle,

determining whether, at the current moment, the external element is in the field of view or outside the field of view of the obstacle detection module of the target vehicle, then generating and sending a driving setpoint to at least one vehicle on the infrastructure when the external element is outside the field of view of the obstacle detection module of the target vehicle.

The invention also relates to a computer program including software instructions which, when executed by a computer, implement a supervision method as defined above.

### BRIEF DESCRIPTION OF THE DRAWINGS

These features and advantages of the invention will appear more clearly upon reading the following description, provided solely as a non-limiting example, and done in reference to the appended drawings, in which:

FIG. 1 is a schematic illustration of a transport system according to the invention in a first basic supervision situation;

FIGS. 2, 3 and 4 are examples of additional supervision situations; and

FIG. 5 is a flowchart of a supervision method according to the invention.

### DESCRIPTION OF THE PREFERRED EMBODIMENTS

In the rest of the description, the expression “substantially equal to” designates a relationship of equality to within plus or minus 10%, preferably to within plus or minus 5%.

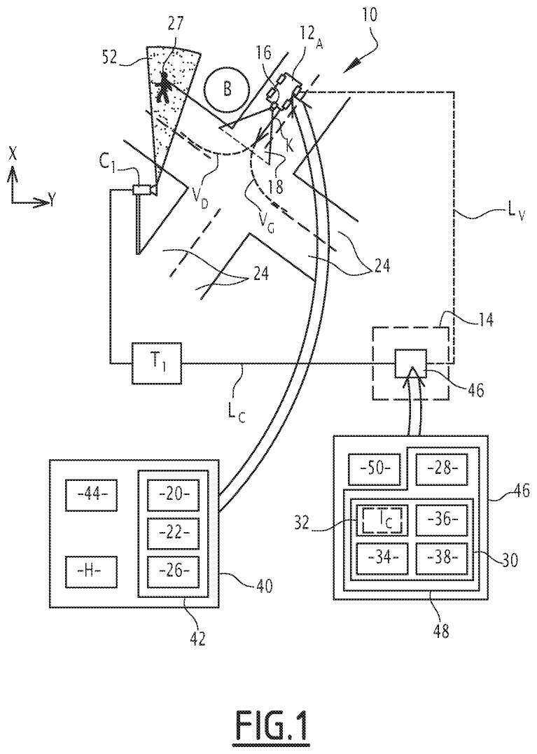

In FIG. 1, a transport system 10 comprises a fleet of vehicles 12, a supervision platform 14 and a plurality of sensors, installed in the road such as the sensor C₁ and/or embedded in a plurality of separate vehicles (not shown). Among the fleet of vehicles 12, at least one vehicle 12 is an autonomous vehicle and is then denoted 12_{A}. The fleet preferably includes a plurality of vehicles 12, each vehicle preferably being an autonomous vehicle 12_{A}.

In the example of FIG. 1, the autonomous vehicle 12_{A} is an autonomous car, an autonomous bus, an autonomous tram, an autonomous train, or any other autonomous means of public transportation, etc.

Such an autonomous vehicle 12_{A} comprises, in a known manner, front wheels, rear wheels, a motor (not shown) mechanically connected via a transmission chain to the front and/or rear wheels for the driving of said wheels in rotation around their axis, a steering system (not shown), suitable for acting on the front and/or rear wheels of the autonomous vehicle 12_{A} so as to modify the orientation of its trajectory, and a braking system (not shown), suitable for exerting a braking force on the wheels of the autonomous vehicle 12_{A}.

One skilled in the art will then understand that the vehicle 12_{A} is shown from above in the schematic view of FIG. 1, the black rectangles symbolizing the wheels of this autonomous vehicle 12_{A}.

According to the invention, such an autonomous vehicle 12_{A} is provided with at least one obstacle detection module 16, the field of view 18 of which is predetermined and known by the supervision platform 14.

Such an obstacle detection module 16 for example comprises one or several sensors embedded within the vehicle corresponding to an image sensor, that is to say, a photosensor or a camera or chosen from the group of sensors comprising at least: a lidar (light detection and ranging), a leddar (light-emitting diode detection and ranging), a radar (radio detection and ranging) and an ultrasound sensor.

Furthermore, as illustrated in FIG. 1, the autonomous vehicle 12_{A} comprises a geolocation module 20, a clock H, and an autonomous driving module 22.

A geolocation module 20 hereinafter refers to an instrument capable of positioning the autonomous vehicle 12_{A} on a plan or map using its geographical coordinates. Such a geolocation module 20 is capable of being located, for example using a satellite positioning system, receiving its geographical position in real time, for example via a GPS receiver, and broadcasting it in real time.

Other geolocation techniques can be used according to the invention, such as geolocation by geocoder, GSM, Wi-Fi, using an inertial unit, a radar or a lidar.

Such geolocation techniques are, according to one specific aspect of the invention, optimized by a map matching technique or a simultaneous localization and mapping (SLAM) technique.

According to one specific aspect of the invention, the geolocation module 20 and the clock H are according to an ASIL D (Automotive Safety Integrity Level) operating safety design effort level, this ASIL D level representing the maximum degree of rigor required to meet the safety requirements associated with a maximum danger level. The ASIL by definition is obtained by multiplying a trio of values respectively representative of three safety criteria, namely the severity, the exposure and the controllability.

In other words, during the design of the autonomous vehicle 12_{A} according to the present invention, the maximum precision level in terms of temporal indication(s) delivered by the clock H and in terms of geographical geolocation precision of the autonomous vehicle 12_{A} delivered by the geolocation module 20 is required.

Hereinafter, autonomous driving module 22 refers to a logic controller suitable for controlling the autonomous vehicle autonomously by receiving information on the environment of the autonomous vehicle 12_{A} by means of sensors, located outside or inside the autonomous vehicle, and by acting on the motor (not shown), the steering system (not shown) and the braking system (not shown) so as to modify the speed and path of the autonomous vehicle 12_{A} in response to the received information and so as to comply with a mission programmed in the logic controller.

In particular, such a mission corresponds to following a predefined path, for example the path followed by a bus or tram line or any other autonomous public transportation means on one or several traffic paths 24, visible in FIG. 1.

Furthermore, the autonomous vehicle 12_{A} comprises a reception and processing module 26 configured to receive, via the dedicated link Lv (optionally secure), and process a driving setpoint sent by the supervision platform 14 in the presence of an external element 27 in a predetermined security zone comprising the predefined route and outside the field of view of its own obstacle detection module 16, according to this example, the autonomous vehicle 12_{A} being the target of the supervision implemented by the supervision platform 14. Such a setpoint in particular corresponds to an order, or a deceleration value or change of route, and is subsequently transferred by the reception module 26 to the autonomous driving module 22 for processing and/or application.

As an optional addition, the reception module 26 is also configured to receive information representative of the position of the external element 27 and to verify that the external element 27 is outside the field of view of the obstacle detection module 16 of the autonomous vehicle 12_{A}, which makes it possible to avoid the application of an additional driving setpoint if, after verification, the external element 27 is visible by the obstacle detection module 16 and the autonomous driving module 22 has intrinsically already taken this external element 27 into account to adapt the behavior of the autonomous vehicle 12_{A}.

The supervision platform 14 is a piece of electronic equipment able to supervise remotely, or control remotely, the fleet of motor vehicle(s) 12, the supervision platform also being called PCC (Poste de Commande Central, central control unit).

According to the invention, the supervision platform 14 comprises an acquisition module 28 configured to acquire, at a current moment, at least one piece of information representative of the presence or absence, in the predetermined safety zone comprising the predefined route, of an element external to the target vehicle 12_{A}, and an analysis and regulating module 30 configured to determine whether, at the current moment, the external element is in the field of view or outside the field of view of the obstacle detection module 16 of the target vehicle 12_{A}, and configured to generate and send a driving setpoint to at least one vehicle on the infrastructure when the external element is outside the field of view of the obstacle detection module of the target vehicle 12_{A}.

“Predetermined safety zone” refers to a geographical zone whose surface area is strictly larger than that corresponding to the predefined route.

According to a first variant, the predetermined safety zone has a surface area with a static size extending on either side of the traffic path with a margin substantially equal to 10 m.

According to a second variant, the predetermined safety zone has a surface with a dynamic size proportional to the speed of the target vehicle.

As an optional addition, the analysis and regulation module 30 comprises a prediction tool 32 able to supply a prediction of the route of the external element 27 and/or at least one prediction of a spatial-temporal contact position between the external element 27 and the target vehicle 12_{A} on the predefined route.

According to one specific aspect of this optional addition, the spatial-temporal position corresponds to an elliptical zone and the prediction tool 32 comprises an instrument I_{C} for calculating parameters of the elliptical zone, the surface of the elliptical zone being proportional to a degree of uncertainty associated with the prediction supplied by the prediction tool 32.

For example, the prediction tool 32 comprises a Kalman filter capable of estimating the states of the dynamic external element 27. More specifically, the Kalman filter is capable of predicting parameters corresponding to the position and the speed of the detected external element 27 and capable of calculating the uncertainties of these parameters.

To that end, a two-dimensional representation along a pair of axes (X, Y) of the position of the external element 27 can be implemented by the prediction tool 32 and the Kalman filter calculates a degree of uncertainty in each dimension. Such a degree of Uncertainty is quite simply a possible deviation measurement, or in a variant, the maximum possible deviation, of the estimated position. In particular, if the degree of uncertainty on X is equal to the degree of uncertainty on Y, the spatial-temporal contact position obtained from two degrees of uncertainty corresponds to a circular zone. Conversely, if the external element 27 moves along the axis X, the degree of uncertainty of the prediction of its position along the axis X is greater than that along Y and the spatial-temporal contact position obtained from two degrees of uncertainty corresponds to an elliptical zone.

According to the example of FIG. 1, the analysis and regulation module 30 further comprises a tool 34 for generating the driving setpoint and a transmission tool 36, which are separate.

According to another per specific aspect, the analysis and regulation module 30 comprises a verification tool 38 configured to verify, at least at one moment after the current moment, the validity of the prediction(s), and configured to adapt the driving setpoint to the later moment as a function of said validity.

Such a tool allows the setpoint generation to be governed in real time as a function of the received observation of external element(s).

In the example of FIG. 1, the target vehicle 12_{A} comprises an information processing unit 40, for example made up of a memory 42 and a processor 44 associated with the memory 42.

In the example of FIG. 1, the geolocation module 20, the autonomous driving module 22 and the reception and processing module 26 are each made in the form of software, or a software component, executable by the processor 44.

The memory 42 of the target vehicle 12_{A} is then able to store first geolocation software to allow the geolocation of the target vehicle 12_{A}, second autonomous driving software suitable for steering the autonomous vehicle autonomously by receiving information on the environment of the autonomous vehicle 12_{A} by means of sensors, located outside or inside the autonomous vehicle, and by acting on the motor (not shown), the steering system (not shown) and the braking system (not shown) so as to modify the speed and path of the autonomous vehicle 12_{A} in response to the received information and so as to comply with a mission programmed in the logic controller, third reception and processing software configured to receive and process a driving setpoint sent by the supervision platform 14 in the presence of an external element 27 both in a predetermined safety zone comprising the predetermined route and outside the field of view of the obstacle detection module of the target vehicle 12_{A}.

The processor 44 is then able to execute each software application from among the first geolocation software, the second autonomous driving software, the third reception and processing software for a driving setpoint sent by the supervision platform 14.

In a variant that is not shown, the geolocation module 20, the autonomous driving module 22 and the reception and processing module 26 are each made in the form of a programmable logic component, such as an FPGA (Field Programmable Gate Array), or in the form of a dedicated integrated circuit, such as an ASIC (Application Specific Integrated Circuit).

When part of the autonomous vehicle 12_{A} is made in the form of one or several software programs, i.e., in the form of a computer program, this part is further able to be stored on a medium, not shown, readable by computer. The computer-readable medium is for example a medium suitable for storing electronic instructions and able to be coupled with a bus of a computer system. As an example, the readable medium is an optical disc, a magnetic-optical disc, a ROM memory, a RAM memory, any type of non-volatile memory (for example, EPROM, EEPROM, FLASH, NVRAM), a magnetic card or an optical card. A computer program including software instructions is then stored on the readable medium.

In the example of FIG. 1, the geolocation module 20, the autonomous driving module 22, the reception and processing module 26 are embedded within only the information processing unit 40, that is to say, within a single and same electronic computer of the autonomous vehicle 12_{A}.

Furthermore, in the example of FIG. 1, the supervision platform 14 also comprises an information processing unit 46 for example formed by a memory 48 and a processor 50 associated with the memory 48.

In the example of FIG. 1, the acquisition module 28, the analysis and regulation module 30 and its tools are each made in the form of software, or a software component, executable by the processor 50.

The memory 48 of the supervision platform 14 is then able to store acquisition software configured to acquire, at a current moment, at least one piece of information representative of the presence or absence, in a predetermined safety zone comprising the predefined route, of an element 27 external to the target vehicle 12_{A}, analysis and regulation software capable of determining whether, at a the current reception moment of a piece of information representative of the presence or absence, in the predetermined safety zone comprising the predefined path, whether the external element 27 is in the field of view or outside the field of view of the obstacle detection module 16 of the target vehicle 12_{A}, and configured to generate and send a driving setpoint to at least one vehicle on the infrastructure when the external element is outside the field of view of the obstacle detection module of the target vehicle.

The processor 50 is then able to execute the acquisition software, the analysis and regulation software and the software tools that it comprises.

In a variant that is not shown, the acquisition module 28, the analysis and regulation module 30 and its tools are each made in the form of a programmable logic component, such as an FPGA (Field Programmable Gate Array), or in the form of a dedicated integrated circuit, such as an ASIC (Application Specific Integrated Circuit).

When part of the supervision platform 14 is made in the form of one or several software programs, that is to say, in the form of a computer program, this part is further able to be stored on a medium, not shown, readable by computer. The computer-readable medium is for example a medium suitable for storing electronic instructions and able to be coupled with a bus of a computer system. As an example, the readable medium is an optical disc, a magnetic-optical disc, a ROM memory, a RAM memory, any type of non-volatile memory (for example, EPROM, EEPROM, FLASH, NVRAM), a magnetic card or an optical card. A computer program including software instructions is then stored on the readable medium.

In the example of FIG. 1, the acquisition module 28, the analysis and regulation module 30 and its tools are integrated within only the information processing unit 46, that is to say, within a single and same electronic computer of the platform 14.

According to the first situation of FIG. 1, the offboard sensor Cᵢ installed in the road has a field of view 52 allowing it to detect, at a current moment, an external element 27 corresponding to a pedestrian.

The offboard sensor C₁ is then configured to escalate instantaneously, or practically instantaneously, via a terminal T₁ and a dedicated link L_{C} (wired or wireless (for example, radio)), optionally secured, information representative of the presence of the pedestrian 27 on the platform 14.

The acquisition module 28 of the supervision platform 14 is configured to acquire, from the offboard sensor C1 installed in the road, this information representative of the presence of the pedestrian 27.

According to a variant that is not shown, the acquisition module 28 of the supervision platform 14 is configured to acquire this information representative of the presence of the pedestrian 27, by an avenue other than that associated with the offboard sensor C₁, for example by following the mobile terminal of the pedestrian 27.

When the external element corresponds to an imminent weather phenomenon such as a very localized bad weather event, a sheet of ice or a natural obstacle, the information representative of the presence of this specific external element is generated by any other device capable of generating it. For example, such information corresponds to an SMS (short message service) sent by a pedestrian and/or a motorist to notify the supervision platform of a fallen tree after a storm or gale.

As an optional addition, the acquisition module 28 is also configured to acquire speed and/or acceleration information associated with the information representative of the presence of the external element 27.

The analysis and regulation module 30 of the supervision platform 14 is first configured to process this information by using the predetermined safety zone comprising the predefined path of the target vehicle 12_{A}.

For example, when the predefined path of the target vehicle 12_{A} is such that at a moment, after the current moment, it comprises a left turn V_{G} relative to the movement vector K of the target vehicle 12_{A}, the analysis and regulation module 30 is capable of determining that the external element corresponding to the pedestrian 27 is absent from the safety zone.

Conversely, when the predefined path of the target vehicle 12_{A} is such that at a moment, after the current moment, it comprises a right turn V_{D} relative to the movement vector K of the target vehicle 12_{A}, the analysis and regulation module 30 is capable of determining that the external element corresponding to the pedestrian 27 is present in the safety zone.

Furthermore, the analysis and regulation module 30 of the supervision platform 14 is capable of taking account of the geolocation position of the target vehicle 12_{A} obtained using the geolocation module 20 of the target vehicle 12_{A} to determine whether elements of the road are obstructing the field of view 18 of the obstacle detection module 16 embedded in the target vehicle 12_{A}.

In relation with the example of FIG. 1, the analysis and regulation module 30 of the supervision platform 14 is in particular able to detect and calculate that the building B is obstructing the field of view 18 of the obstacle detection module 16 embedded in the target vehicle 12_{A} and that as a result, the external element corresponding to the pedestrian 27 detected by the sensor C₁ installed in the road is outside the field of view 18 of the obstacle detection module 16 of the target vehicle 12_{A}.

In this configuration, the obstacle detection module 16 of the target vehicle 12_{A} not “seeing” the external element corresponding to the pedestrian 27, the autonomous driving module 22 cannot anticipate this potentially disruptive external element and automatically adapt the route/speed of the target vehicle 12_{A}.

In the presence of a dual condition corresponding to an external element 27 that is both in the safety zone comprising the predefined path of the target vehicle 12_{A} and outside the field of view 18 of the obstacle detection module 16 of the target vehicle 12_{A}, the analysis and regulation module 30 of the supervision platform 14 generates and transmits a driving setpoint to at least one vehicle in the infrastructure.

According to a first variant, the vehicle receiving the setpoint is the target vehicle 12_{A}.

Alternatively and/or in addition to the first variant, the vehicle receiving the setpoint is a vehicle other than the target vehicle 12_{A}.

According to an optional additional aspect, the external element is configured to be classified by the supervision platform according to the invention according to several categories, comprising at least:

another vehicle, separate from the target vehicle,

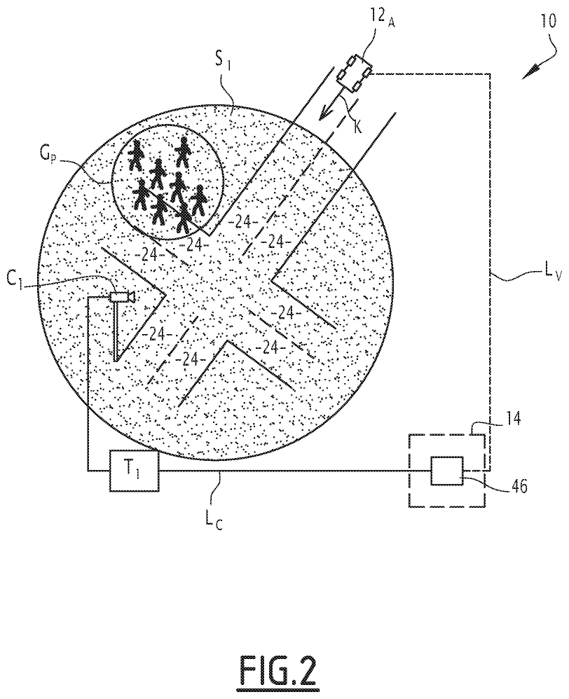

a pedestrian 27 or a group of pedestrians G_{P} as illustrated in the exemplary situation of FIG. 2,

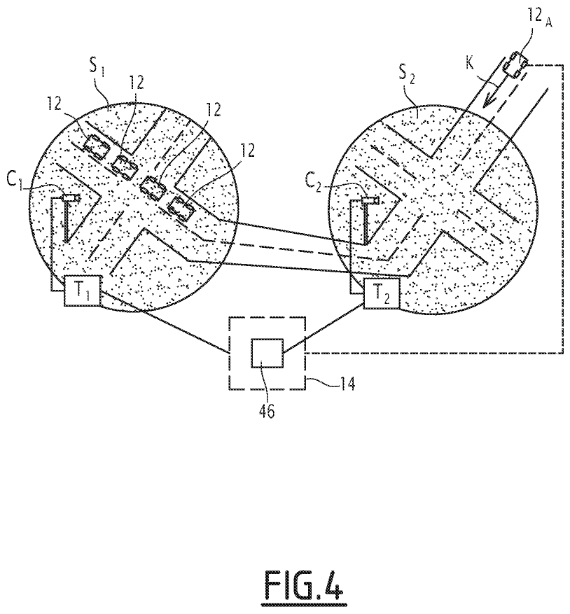

traffic congestion as illustrated in FIG. 4,

a bicyclist or group of bicyclists,

a construction or restricted traffic zone,

a weather phenomenon,

a natural obstacle, such as a tree, a branch, an animal, etc.

According to the second situation of FIG. 2, the offboard sensor C₁ installed in the road of the supervision site S₁ is configured to detect, at a current moment, an external element 27 corresponding to a group of pedestrians G_{P} who are crossing the traffic path 24 or walking on the sidewalk such as pedestrians leaving a high school, a movie theater, or located at a bus stop.

The target vehicle 12_{A} approaches the supervision site S₁, and its obstacle detection module 16 (not shown in FIG. 2 for simplification reasons) has a range known by the supervision platform 14 but shorter than the distance separating it from the group of pedestrians G_{P}, which is therefore outside its field of view.

Owing to the present invention, the supervision platform 14 is capable of processing the information representative of the presence of the group of pedestrians G_{P} transmitted by the processing terminal T₁ directly connected to the offboard sensor C₁. More specifically, the analysis and regulation module 30 of the supervision platform 14 is capable of taking account of the geolocation position of the target vehicle 12_{A} obtained using the geolocation module 20 of the target vehicle 12_{A} to determine that the group of pedestrians G_{P} is located in the safety zone comprising the predefined path of the target vehicle 12_{A}, and that because of the distance separating the target vehicle 12_{A} from the group of pedestrians G_{P}, the group of pedestrians is outside the field of view of the obstacle detection module 16.

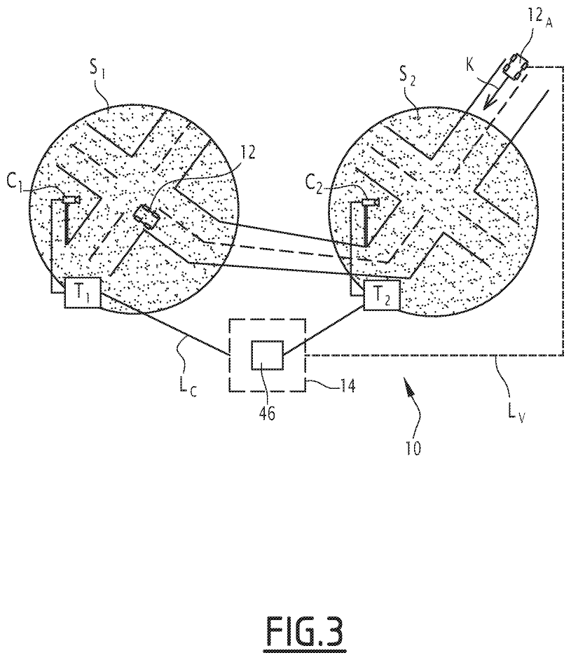

According to the third situation of FIG. 3, the supervision platform 14 takes advantage of the fact that it is capable of acquiring, from several close successive separate geographical sites S₁, S₂ (that is to say, which do not overlap and are for example 100 to 600 m apart) traveled by the predefined path of the target vehicle 12_{A}, one or several pieces of information representative of external elements capable of constituting one or several potential obstacles.

In other words, the supervision platform 14 in particular allows a transfer to the site S₂ of a setpoint taking account of a piece of information relative to the site S₁ in which the offboard sensor C₁ is in particular configured to escalate, via the terminal T₁ and the dedicated link L_{C}, the presence of an external element corresponding to the vehicle 12 that is moving at a high speed such as a police vehicle, an ambulance, a private vehicle.

More specifically, the target vehicle 12_{A} moves from the site S₂ toward the site S₁ and the supervision platform 14, via the prediction tool 32, is capable of predicting the route of the vehicle 12 from the site S₁ and determining that this vehicle 12 appears be moving, in particular at a high speed, toward the site S₂.

More specifically, the prediction tool 32 is capable of providing, on a timescale, the successive positions of the vehicle 12 and a spatial-temporal contact position between the vehicle 12 and the target vehicle 12_{A} on the predefined path.

In light of this prediction and the fact that the vehicle 12 located on the site 51 is out of range of the obstacle detection module 16 (not shown in FIG. 3 for simplification reasons) of the target vehicle 12_{A}, the supervision platform 14 is capable of generating a deceleration setpoint to the attention of the target vehicle 12_{A}.

As an optional addition, the verification tool 38 of the analysis and regulation module 30 of the supervision platform 14 is capable of verifying, in real time, whether these predictions are satisfied and in case of invalidation, modifying or deleting the driving setpoint previously transmitted.

In particular, to perform such a verification, the verification tool 38 of the analysis and regulation module 30 is capable of using information provided by a sensor O₂ separate from the sensor C₁, which, at the current moment, has provided the information representative of the presence of the vehicle 12 on the predefined path on the site 51.

According to the fourth situation of FIG. 4, the supervision platform 14 takes advantage of the fact that it is capable of acquiring, from several distant successive separate geographical sites S₁, S₂ (that is to say, which do not overlap and are for example 600 m to 2 km apart) traveled by the predefined path of the target vehicle 12_{A}, one or several pieces of information representative of external elements capable of constituting one or several potential obstacles.

According to this fourth situation, the target vehicle 12_{A} is moving from the site S₂ toward the site S₁, and the offboard sensor C₁ is in particular capable of escalating, via the terminal T₁ and the dedicated link L_{C}, the presence of an external element corresponding to traffic congestion of four vehicles 12, such as a traffic jam or a traffic accident.

The supervision platform 14 according to this example is capable of classifying the detected external elements and adapting the driving setpoint as a function of the obtained class. According to the fourth situation, because the external element is traffic congestion capable of blocking traffic up to the predicted spatial-temporal contact position between the traffic congestion, corresponding to the four vehicles 12 stopped on the site S₁, and the target vehicle 12_{A}, the generated driving setpoint this time corresponds to a change of route and not to a deceleration as applied in the preceding situations.

In other words, according to this aspect, the supervision platform 14 is “smart” and capable of performing a bijective association of an external element class and a setpoint type.

Like for the third situation, the verification tool 38 of the analysis and regulation module 30 of the supervision platform 14 is capable of verifying, in real time, whether these predictions are fulfilled (that is to say, the evolution of the traffic congestion), in particular using a sensor C₂ separate from the sensor C₁ that supplied, at the current moment, the information representative of the presence of the vehicle 12 on the predefined path on the site S₁, and in case of invalidation, modifying or even deleting the driving setpoint previously transmitted.

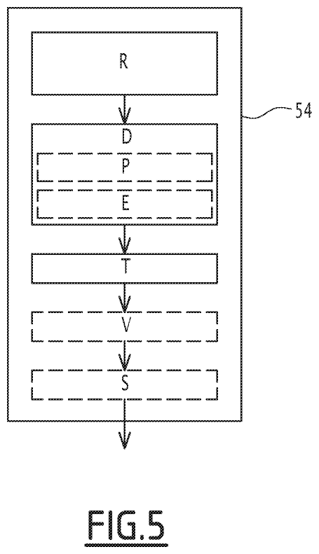

The operation of the supervision platform 14 according to the invention will now be explained using FIG. 5, showing a flowchart of the method 54 according to the invention for supervising an infrastructure for transport vehicles, in particular autonomous, that is capable of moving on an infrastructure for transport vehicles that is supervised by such a supervision platform, at least one target vehicle comprising at least one obstacle detection module with a predetermined field of view and a geolocation module that are embedded, said target vehicle being configured to follow a predefined route on the infrastructure, the method being implemented by the platform for supervising the infrastructure 14.

During an initial step R, the supervision platform 14 acquires, at a current moment, at least one piece of information representative of the presence or absence, in a predetermined safety zone comprising the predefined route, of an element 27, G_{P} outside the target vehicle 12_{A}.

Optionally, the supervision platform 14 simultaneously acquires speed information, or acceleration information, associated with the information representative of the presence or absence, in a predetermined safety zone comprising the predefined route, of an element 27, G_{P} outside the target vehicle 12_{A}.

The supervision platform 14 next determines, during an analysis and regulating step D, whether, at the current moment, the external element 27, G_{P} is in the field of view or outside the field of view of the obstacle detection module 16 of the target vehicle 12_{A}, and configured to generate and send a driving setpoint to at least one vehicle on the infrastructure when the external element 27, G_{P} is outside the field of view of the obstacle detection module 16 of the target vehicle 12_{A}.

According to optional additional aspects shown in dotted lines, the analysis and regulation step D comprises two intermediate steps:

a step P, in which the prediction tool 32 of the analysis and regulation module 30 supplies at least one prediction of the route of the external element 27, G_{P} and/or at least one prediction of a spatial-temporal contact position between the external element and the target vehicle 12_{A} on the predefined route.

a step E, in which, when the spatial-temporal position corresponds to an elliptical zone, the calculating instrument I_{C} of the prediction tool 32 calculates parameters of the elliptical zone, the surface of the elliptical zone being proportional to a degree of uncertainty associated with the prediction P supplied by the prediction tool.

More specifically, the prediction step P comprises predicting the path of the external element from its position and its speed vector (or its acceleration vector if obtained during the acquisition step R), determining the point of intersection (if one exists) of the path of the external element with the predefined path of the target vehicle and determining the time period TTC that separates the current moment from the moment of arrival of the external element at this point, determining the future position of the target vehicle on its predefined path once the period TTC has elapsed from its dynamic parameters (speed, acceleration, etc.), the risk of a collision being proportional to the distance between this future position and the point of intersection).

Following the analysis and regulation step D, during a step T, the generating tool 34 generates and the transmission tool 36 transmits a driving setpoint to at least one vehicle on the infrastructure when the external element 27, G_{P} is outside the field of view of the obstacle detection module 16 of the target vehicle (12_{A}), such a setpoint being, as previously described, adapted to the situation being supervised.

During an optional subsequent step V, the supervision platform 14 uses its verification tool 38 to verify whether the predictions obtained during step P are valid.

Based on the result of the verification step V during a step S, which is also optional, the supervision platform 14 generates a modification setpoint, or a deletion setpoint for the driving setpoint previously generated.

Thus, the supervision platform 14 according to the invention, while filtering the information acquired using the set of embedded/offboard sensor(s) and monitoring devices to which it is connected and able to assist the target vehicle that it is supervising to allow it, or to allow other vehicles present on the infrastructure, to better anticipate any element that may constitute a potential obstacle and that is not visible by the obstacle detection module 16 embedded in the target vehicle 12_{A}.

One can thus see that the supervision platform 14 according to the invention makes it possible to offer more effective monitoring and improved safety for vehicles traveling on the infrastructure that it is supervising by addressing the obstructions in the field of view or the lack of range of the obstacle detection modules embedded in vehicles.

1. A platform for supervising an infrastructure for transport vehicles at least one target vehicle comprising at least one obstacle detection module with a predetermined field of view and a geolocation module that are embedded, said target vehicle being configured to follow a predefined route on the infrastructure, the platform comprising:
an acquisition module configured to acquire, at a current moment, at least one piece of information representative of the presence or absence, in a predetermined safety zone comprising the predefined route, of an element outside the target vehicle, and
an analysis and regulating module configured to determine whether, at the current moment, the external element (27, G_{P}) is in the field of view or outside the field of view of the obstacle detection module (16) of the target vehicle, and configured to generate and send a driving setpoint to at least one vehicle on the infrastructure when the external element is outside the field of view of the obstacle detection module of the target vehicle.

2. The platform according to claim 1, wherein, when the element external to the target vehicle is moving, the acquisition module is also configured to receive speed and/or acceleration information associated with the information representative of the presence of the external element.

3. The platform according to claim 2, wherein the analysis and regulation module comprises a prediction tool configured to supply a prediction of the route of the external element and/or at least one prediction of a spatial-temporal contact position between the external element and the target vehicle on the predefined route.

4. The platform according to claim 3, wherein the spatial-temporal position corresponds to an elliptical zone and wherein the prediction tool comprises an instrument (I_{C}) for calculating parameters of the elliptical zone, the surface of the elliptical zone being proportional to a degree of uncertainty associated with the prediction supplied by the prediction tool.

5. The platform according to claim 3, wherein the analysis and regulation module comprises a verification tool configured to verify, at least at one moment after the current moment, the validity of the prediction(s), and configured to adapt the driving setpoint to the later moment as a function of said validity.

6. The platform according to claim 1, wherein the platform is configured to classify the external element according to several categories comprising at least:
another vehicle, separate from the target vehicle,
traffic congestion,
a pedestrian or group of pedestrians,
a bicyclist or group of bicyclists,
a construction or restricted traffic zone,
a weather phenomenon,
a natural obstacle,
and to adapt the type of setpoint based on the category of external element.

7. A vehicle, configured to move on an infrastructure for transport vehicles supervised by a supervision platform according to claim 1, at least one target vehicle comprising at least one obstacle detection module with a predetermined field of view and a geolocation module that are embedded, said target vehicle being configured to follow a predetermined route on the infrastructure,
wherein said vehicle comprises a reception and processing module configured to receive and process a driving setpoint sent by the supervision platform in the presence of an external element both in a predetermined safety zone comprising the predetermined route and outside the field of view of the obstacle detection module of the target vehicle.

8. A transport system comprising a fleet of vehicles that are capable of moving on an infrastructure for transport vehicles, the fleet of vehicles comprising at least one target vehicle comprising at least one obstacle detection module with a predetermined field of view and a geolocation module that are embedded, said target vehicle being configured to follow a predefined route on the infrastructure,
the system further comprising a supervision platform according to claim 1, wherein at least one vehicle of the fleet of vehicles comprises a reception and processing module configured to receive and process a driving setpoint sent by the supervision platform in the presence of an external element both in a predetermined safety zone comprising the predetermined route and outside the field of view of the obstacle detection module of the target vehicle.

9. A method for supervising an infrastructure for transport vehicles, at least one target vehicle comprising at least one obstacle detection module with a predetermined field of view and a geolocation module that are embedded, said target vehicle being able to follow a predefined route on the infrastructure, the method being implemented by a platform for supervising the infrastructure, the method comprising the following steps:
acquiring, at a current moment, at least one piece of information representative of the presence or absence, in a predetermined safety zone comprising the predefined route, of an element outside the target vehicle,
determining whether, at the current moment, the external element is in the field of view or outside the field of view of the obstacle detection module of the target vehicle, then generating and sending a driving setpoint to at least one vehicle on the infrastructure when the external element is outside the field of view of the obstacle detection module of the target vehicle.

10. A non-transitory computer-readable medium on which is stored a computer program comprising software instructions which, when executed by a computer, carry out a supervision method according to claim 9.
